(19) United States
(12) Patent Application Publication
(10) Pub. No.: US 2017/0283081 A1
(43) Pub. Date: Oct. 5, 2017

(54) SECURING A TRANSLATING FANLET FOR AN AIRCRAFT PROPULSION SYSTEM NACELLE

(71) Applicant: Rohr, Inc., Chula Vista, CA (US)

(72) Inventor: Steven M. Kestler, Winchester, CA (US)

(21) Appl. No.: 15/091,235

(22) Filed: Apr. 5, 2016

(51) Int. Cl. B64D 29/06; F02C 7/04; B64D 27/16; B64D 27/26

(52) U.S. Cl. CPC B64D 29/06; B64D 27/26; F02C 7/04; B64D 27/16

(57) ABSTRACT

A nacelle includes a stationary support, a forward nacelle structure, a latch assembly and an aft nacelle structure. The stationary support extends circumferentially about an axial centerline. The forward nacelle structure is configured to translate axially along the centerline between an aft stowed position and a forward deployed position. The latch assembly is configured to secure an aft end portion of the forward nacelle structure to the stationary support where the forward nacelle structure is in the aft stowed position. The aft nacelle structure is configured to translate axially along the centerline between a forward stowed position and an aft deployed position. A forward end portion of the aft nacelle structure axially covers the aft end portion of the forward nacelle structure and the latch assembly where the forward nacelle structure is in the aft stowed position and the aft nacelle structure is in the forward stowed position.

### BACKGROUND OF THE INVENTION

### 1. Technical Field

This disclosure relates generally to an aircraft propulsion system and, more particularly, to a nacelle with interfacing translatable structures such as, for example, a translating fanlet and a translating sleeve.

### 2. Background Information

Some modern nacelle designs may include multiple translatable structures which meet one another at an interface when stowed. Examples of such translatable structures include a forward fanlet. The fanlet may be secured in its stowed position using one or more latches. While various types of latches are known in the art, implementation of such latches may require disruptions in an exterior surface of the nacelle; e.g., windows to accommodate latch handles, etc. Such disruptions may cause disruptions in boundary layer airflow around the nacelle and thereby may decrease engine efficiency and increase fuel consumption.

There is a need in the art for a nacelle configuration which reduces disruptions in boundary layer airflow proximate an interface between.

### SUMMARY OF THE DISCLOSURE

According to an aspect of the present disclosure, a nacelle is provided for an aircraft propulsion system. This nacelle includes a stationary support, a forward nacelle structure, a latch assembly and an aft nacelle structure. The stationary support extends circumferentially about an axial centerline. The forward nacelle structure is configured to translate axially along the centerline between an aft stowed position and a forward deployed position. The latch assembly is configured to secure an aft end portion of the forward nacelle structure to the stationary support where the forward nacelle structure is in the aft stowed position. The aft nacelle structure is configured to translate axially along the centerline between a forward stowed position and an aft deployed position. A forward end portion of the aft nacelle structure axially covers the aft end portion of the forward nacelle structure and the latch assembly where the forward nacelle structure is in the aft stowed position and the aft nacelle structure is in the forward stowed position.

According to another aspect of the present disclosure, a nacelle is provided for an aircraft propulsion system. This nacelle includes a stationary support, a forward nacelle structure, a latch assembly and an aft nacelle structure. The stationary support extends circumferentially about an axial centerline. The forward nacelle structure is configured to translate axially along the centerline between an aft stowed position and a forward deployed position. The latch assembly is configured to secure an aft end portion of the forward nacelle structure to the stationary support where the forward nacelle structure is in the aft stowed position. A forward end portion of the aft nacelle structure axially covers the aft end portion of the forward nacelle structure and the latch assembly where the forward nacelle structure is in the aft stowed position.

According to another aspect of the present disclosure, another nacelle is provided for an aircraft propulsion system. This nacelle includes a stationary support, a fanlet, a latch assembly and a sleeve. The stationary support extends circumferentially about an axial centerline. The fanlet includes an inlet structure and a fan cowl. The fanlet is axially translatable along the centerline. The latch assembly is configured to secure an aft end portion of the fanlet to the stationary support when the fanlet is stowed. The sleeve is axially translatable along the centerline. When the sleeve and the fanlet are stowed, the sleeve covers the latch assembly and an exterior surface of the sleeve is substantially flush with and adjacent to an exterior surface of the fanlet.

According to another aspect of the present disclosure, a method is provided for securing a nacelle. This method includes steps of: (a) translating a fanlet from an open position to a closed position, the translating occurring in a direction substantially parallel to a centerline axis of the nacelle; (b) latching the fanlet to an aft stationary structure using one or more latches; and (c) moving a portion of a thrust reverser to cover the one or more latches so the one or more latches are not exposed to any aerodynamic flow during flight.

The forward nacelle structure may be configured as or otherwise includes a fanlet. In addition or alternatively, the aft nacelle structure is configured as or otherwise includes a sleeve configured to translate axially along the centerline between a forward stowed position and an aft deployed position.

The forward nacelle structure may be configured as or otherwise includes a fanlet. In addition or alternatively, the fanlet may include an inlet structure and a fan cowl.

The aft end portion of the forward nacelle structure may axially overlap the stationary support where the forward nacelle structure is in the aft stowed position.

The forward end portion of the aft nacelle structure may be radially outboard of the aft end portion of the forward nacelle structure where the forward nacelle structure is in the aft stowed position and/or the aft nacelle structure is in the forward stowed position.

When the forward nacelle structure is in the aft stowed position and/or the aft nacelle structure is in the forward stowed position, an exterior surface of the aft nacelle structure may be substantially flush with and adjacent to an exterior surface of the forward nacelle structure.

The aft end portion of the forward nacelle structure may be adjacent to and aft of the exterior surface of the forward nacelle structure.

The aft end portion of the forward nacelle structure may be radially recess inward from the exterior of the forward nacelle structure and the exterior surface of the aft nacelle structure.

The latch assembly may include a plurality of latches disposed circumferentially about the centerline.

The latch assembly may be configured as or otherwise include a manually operated latch.

The latch may include a handle operable to engage and disengage the latch where the aft nacelle structure is in the aft deployed position. The forward end portion of the aft nacelle structure may be configured to inhibit the handle from disengaging the latch where the aft nacelle structure is in the forward stowed position.

A thrust reverser system may be included and configured to operate where the aft nacelle structure is in the aft deployed position. The stationary support may be configured as or otherwise include a torque box for the thrust reverser system.

A forward end portion of the sleeve may axially cover the aft end portion of the fanlet and the latch assembly where the fanlet and the sleeve are stowed.

The aft end portion of the fanlet may axially overlap the stationary support where the fanlet is stowed.

The aft end portion of the fanlet may be adjacent to and aft of the exterior surface of the fanlet.

The aft end portion of the fanlet may be radially recess inward from the exterior of the fanlet and the exterior surface of the sleeve.

The latch may include a handle operable to engage and disengage the latch where the sleeve is deployed. The sleeve may be configured to inhibit the handle from disengaging the latch where the sleeve is stowed.

The foregoing features and the operation of the invention will become more apparent in light of the following description and the accompanying drawings.

### BRIEF DESCRIPTION OF THE DRAWINGS

FIG. 1 is a side illustration of an aircraft propulsion system with a translatable fanlet and a translatable sleeve in stowed positions.

FIG. 2 is a side illustration of the aircraft propulsion system with the fanlet in a partially deployed position and the sleeve in the stowed position.

FIG. 3 is a side illustration of the aircraft propulsion system with the fanlet in the stowed position and the sleeve in a fully deployed position.

FIG. 4 is a side sectional illustration of a portion of the aircraft propulsion system at an interface between the fanlet and the sleeve.

FIG. 5 is an end block diagram illustration of a stationary support and a latch assembly for the aircraft propulsion system.

FIG. 6 is an illustration of a latch in an engaged configuration securing the fanlet to the stationary support.

FIG. 7 is an illustration of the latch of FIG. 6 in a disengaged configuration.

FIG. 8 is an illustration of another latch in a disengaged configuration.

FIG. 9 is an illustration of the latch of FIG. 8 in an engaged configuration securing the fanlet to the stationary support.

FIG. 10 is a side sectional illustration of a portion of another aircraft propulsion system at an interface between a fanlet and an aft nacelle structure.

### DETAILED DESCRIPTION OF THE INVENTION

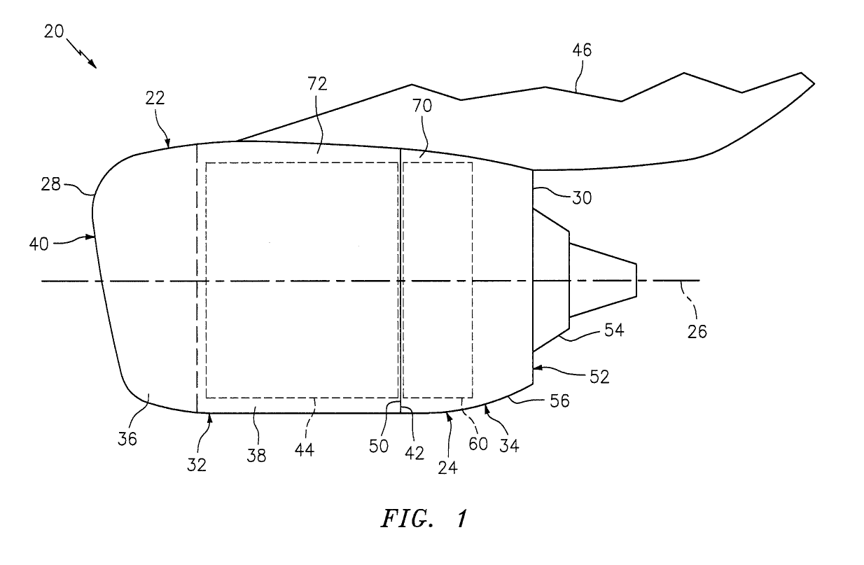

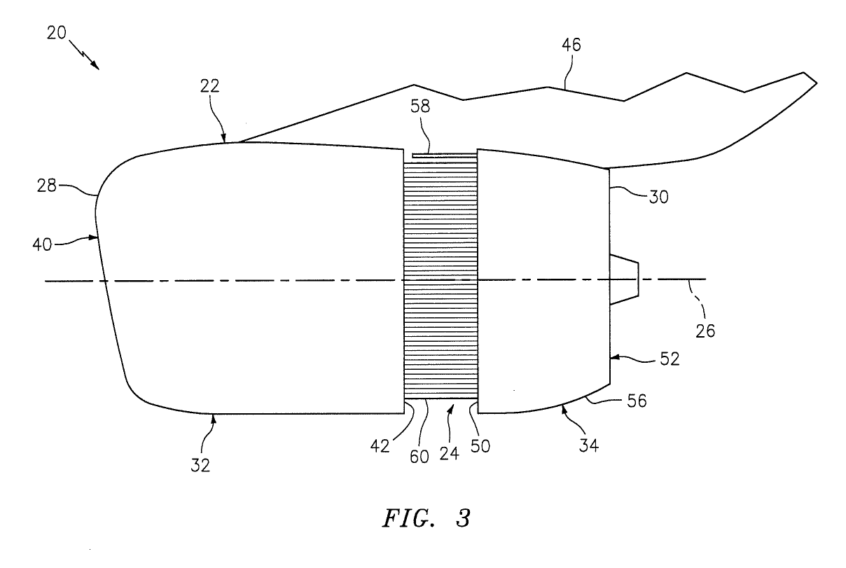

FIG. 1 illustrates an aircraft propulsion system 20 for an aircraft such as a commercial airliner. The propulsion system 20 includes a nacelle 22 and a gas turbine engine. This gas turbine engine may be configured as a turbofan engine. Alternatively, the gas turbine engine may be configured as a turbojet engine or any other type of gas turbine engine capable of propelling the aircraft. The propulsion system 20 also includes a thrust reverser system 24 configured with the nacelle 22; see also FIG. 3.

The nacelle 22 circumscribes the gas turbine engine to provide an aerodynamic covering for the gas turbine engine. The nacelle 22 also forms a bypass gas path with the gas turbine engine, whereby the bypass gas path bypasses a core of the gas turbine engine and is operable to route a majority of air flowing through the propulsion system 20 to produce a majority of thrust (e.g., more than 75%) of the aircraft propulsion system 20 in the case of a turbofan engine configuration. The air through the bypass gas path is propelled by the turbofan.

The nacelle 22 extends along an axial centerline 26 between a forward nacelle end 28 and an aft nacelle end 30. The nacelle 22 includes a forward nacelle structure 32 and an aft nacelle structure 34.

The forward nacelle structure 32 may be configured as a fanlet, and is referred to below as a fanlet for ease of description. This fanlet 32 includes an inlet structure 36 (e.g., cowl or module) and a fan cowl 38, which may be joined together as one unitary structure or assembly. Of course in other embodiments, the fanlet 32 may also include one or more additional structures/components such as an acoustic inner barrel, etc.

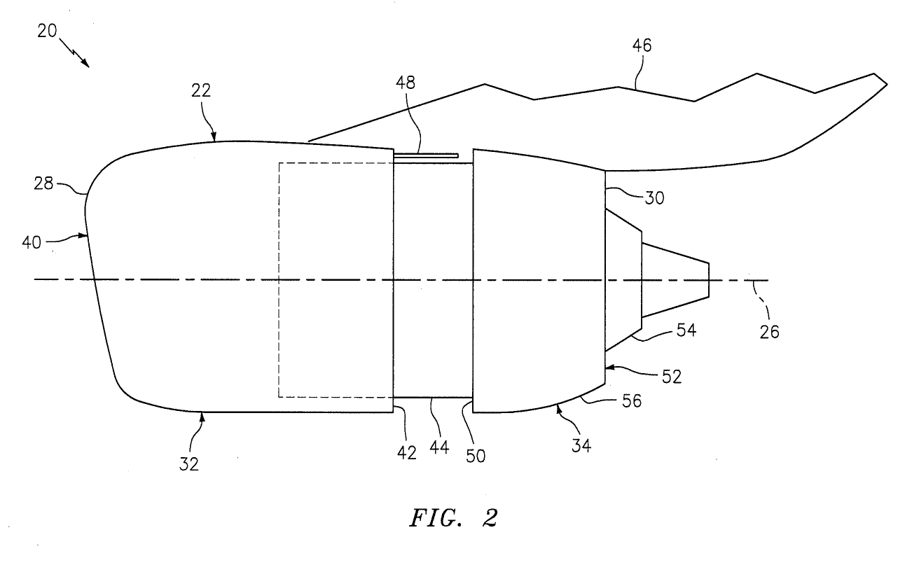

The inlet structure 36 is disposed at the forward nacelle end 28. The inlet structure 36 is configured to direct a stream of air through an inlet orifice 40 at the forward nacelle end 28 and into the propulsion system 20 towards the gas turbine engine. The fan cowl 38 is disposed at an aft end 42 of the fanlet 32 and extends axially between the inlet structure 36 and the aft nacelle structure 34. The fan cowl 38 may be generally axially aligned with a fan section of the gas turbine engine. The fan cowl 38 is configured to provide an aerodynamic covering for a fan case 44 (see also FIG. 2) which circumscribes the fan section.

Referring to FIGS. 1 and 2, the fanlet 32 is configured as a cohesive, translatable structure. In particular, the inlet structure 36 forms a forward portion of the fanlet 32 and the fan cowl 38 forms an aft portion of the fanlet 32. The fanlet 32 is slidably connected to a stationary structure 46, such as a pylon for the aircraft propulsion system 20, through rails 48 (see FIG. 2) mounted on opposing sides of the stationary structure 46 and/or other suitable translatable joints. In this manner, the entire fanlet 32 including the inlet structure 36 and the fan cowl 38 may translate axially along the centerline 26 as shown in FIGS. 1 and 2. The fanlet 32 may thereby move axially between an aft stowed position (see FIG. 1) and a forward deployed position/open position, where FIG. 2 illustrates the fanlet 32 in a partially-deployed forward position. In the aft stowed position, the inlet structure 36 and the fan cowl 38 provide the functionality described above. In the forward deployed positions, the fanlet 32 at least partially (or substantially completely) uncovers at least the fan case 44 and devices and systems mounted thereto (not shown for ease of illustration). This may facilitate propulsion system 20 assembly and maintenance.

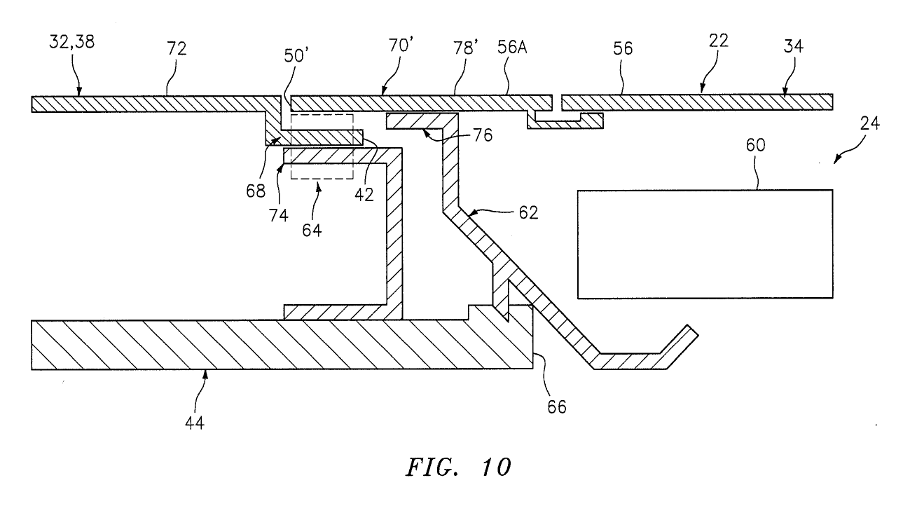

Referring to FIG. 1, the aft nacelle structure 34 is disposed at the aft nacelle end 30 and extends axially between a forward end 50 thereof and the aft nacelle end 30. The aft nacelle structure 34 is configured to provide an outer boundary for an axial portion of the bypass gas path, which extends through the propulsion system 20 to a bypass gas path exhaust nozzle 52. The aft nacelle structure 34 may also form the exhaust nozzle 52 with an inner fairing assembly 54 (e.g., an inner fixed structure), which houses the core of the gas turbine engine. The aft nacelle structure 34 may be configured as or otherwise include with the thrust reverser system 24 for providing reverse thrust upon aircraft landing. The thrust reverser system 24 may include any of a number of known and suitable thrust reverser designs, including those which feature a translating sleeve 56 for translating between a forward stowed position and an aft deployed position for covering and uncovering a set of aerodynamic cascades that redirect the fan bypass air. The aft nacelle structure 34 may also include other components such as, but not limited to, blocker doors, etc. However, in other embodiments, the aft nacelle structure 34 may be a fixed, stationary structure. In still other embodiments, the aft nacelle structure 34 may also include a fixed, stationary structure 56A between the fanlet 32 and the translating sleeve 56 as shown in FIG. 10.

Referring again to FIG. 1, the sleeve 56 may have a substantially tubular unitary sleeve body; e.g., may extend more than three-hundred and thirty degrees around the centerline 26. Alternatively, the sleeve 56 may include a pair of sleeve segments (e.g., halves) arranged on opposing sides of the propulsion system 20. The present disclosure, however, is not limited to the foregoing exemplary sleeve configurations.

Referring to FIGS. 1 and 3, a portion of the aft nacelle structure 34 and, more particularly, the sleeve 56 is configured may be a translatable structure. The sleeve 56, for example, is slidably connected to the stationary structure 46 (e.g., the pylon) through rails 58 (see FIG. 3) mounted on beams which are in turn mounted to opposing sides of the stationary structure 46 and/or other suitable translatable joints. In this manner, the sleeve 56 may translate axially along the centerline 26. The sleeve 56 may thereby move axially between a forward stowed position (see FIG. 1) and an aft deployed position (see FIG. 3). In the forward stowed position, the aft nacelle structure 34 provides the functionality described above. In the aft deployed position, the sleeve 56 at least partially (or substantially completely) uncovers at least one or more other components of the thrust reverser system 24 such as, but not limited to, one or more cascades 60 of vanes.

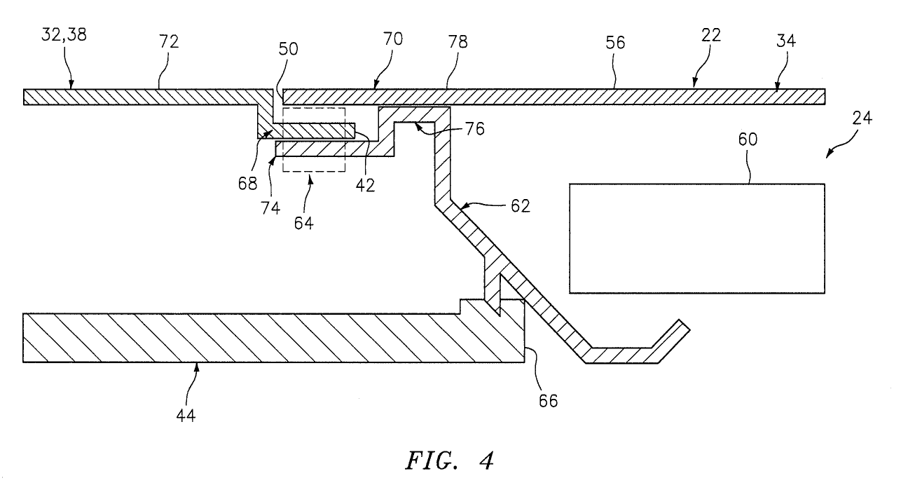

Referring now to FIG. 4, the nacelle 22 also includes a stationary support 62 and a latch assembly 64 (shown in block form by a dashed line). The stationary support 62 extends circumferentially about the centerline 26 and substantially circumscribes the fan case 44. The stationary support 62, for example, may include a pair of parti-annular segments (e.g., halves) arranged on opposing sides of the propulsion system 20. Alternatively, the stationary support 62 may have a substantially annular unitary body; e.g., may extend up to or more than three-hundred and thirty degrees around the centerline 26.

The stationary support 62 is configured to provide a structural support member for the fanlet 32 and the sleeve 56 as described below in further detail. The stationary support 62 may also be configured as a torque box for the thrust reverser system 24. This stationary support 62 is mounted to the fan case 44 at (e.g., on, adjacent or proximate) an aft end 66 of the fan case 44.

The stationary support 62 interfaces with an aft end portion 68 of the fanlet 32 and a forward end portion 70 of the sleeve 56 when the fanlet 32 and the sleeve 56 are stowed. The aft end portion 68 of the fanlet 32 may be configured as a jog in the body of the fanlet 32 at its aft end 42. In particular, the aft end portion 68 of FIG. 4 is configured as an arcuate rim (or one or more circumferentially disposed flanges), which is radially recessed inward from an adjacent portion of the fanlet 32. In this manner, the aft end portion 68 is displaced a distance radially inward from and axially adjacent to an exterior surface 72 of the adjacent portion of the fanlet 32, where this exterior surface 72 forms a portion of an outermost aerodynamic surface of the nacelle 22 (see also FIG. 1).

When the fanlet 32 is stowed, the aft end portion 68 is radially outboard of a fanlet land portion 74 of the stationary support 62. The aft end portion 68 also axially overlaps and may radially engage the fanlet land portion 74. This engagement may be a direct engagement where the aft end portion 68 radially contacts the fanlet land portion 74. Alternatively, the engagement may be an indirect engagement where, for example, at least one rub strip is disposed between the aft end portion 68 and the fanlet land portion 74. This rub strip may be mounted to the fanlet 32 or the stationary support 62.

Referring still to FIG. 4, the forward end portion 70 of the sleeve 56 is disposed at the forward end 50 of the sleeve 56. When the sleeve 56 is stowed, the forward end portion 70 is radially outboard of a sleeve land portion 76 of the stationary support 62 as well as the aft end portion 68 of the fanlet 32. The forward end portion 70 also axially overlaps and thereby covers the stationary support 62 and the aft end portion 68. With this configuration, an exterior surface 78 of the forward end portion 70 and, thus, the sleeve 56 is substantially flush with and adjacent to the exterior surface 72 of the fanlet 32, where the exterior surface 78 forms another portion of the outermost aerodynamic surface of the nacelle 22 (see also FIG. 1).

The forward end portion 70 may radially engage the sleeve land portion 76. This engagement may be a direct engagement where the forward end portion 70 radially contacts the sleeve land portion 76. Alternatively, the engagement may be an indirect engagement where, for example, at least one rub strip is disposed between the forward end portion 70 and the sleeve 56 land portion. This rub strip may be mounted to the sleeve 56 or the stationary support 62.

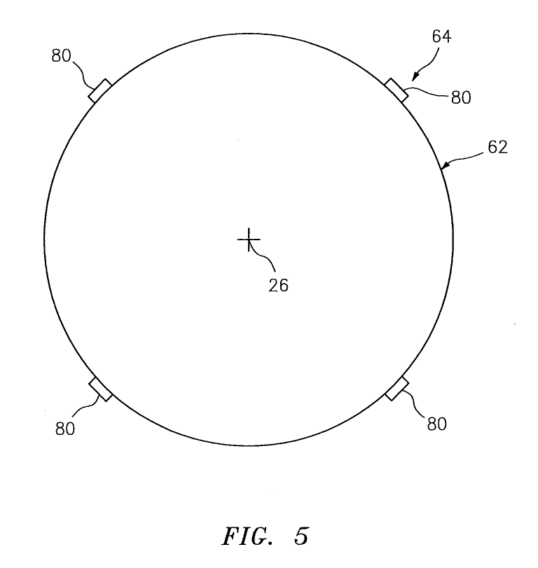

The latch assembly 64 of FIG. 4 is configured to secure the aft end portion 68 of the fanlet 32 to the stationary support 62; e.g., the fanlet land portion 74 of the stationary support 62. This latch assembly 64 may include a single latch, or a plurality of latches 80 arranged in a circular array about the centerline 26 as shown in FIG. 5. When one or more of these latch(es) 80 is/are engaged, the latch assembly 64 temporarily mechanically fastens the aft end portion 68 to the fanlet land portion 74 thereby preventing axial and/or radial movement between those components 68 and 74. However, when all of the latch(es) 80 is/are disengaged, the latch assembly 64 enables axial movement between the aft end portion 68 and the fanlet land portion 74 such that the fanlet 32 may axially translate and open (e.g., deploy) (see FIG. 2).

The latch assembly 64 and its latch(es) 80 are arranged and configured with the fanlet 32 and the stationary support 62 so as to be covered by the forward end portion 70 when the sleeve 56 is stowed. In this manner, the latch assembly 64 does not disrupt boundary layer airflow around the nacelle 22 when the aircraft propulsion system 20 is operating under normal (e.g., cruise) flight conditions and thereby reduces drag. As known in the art, reducing drag will increase aircraft propulsion system 20 efficiency and decrease fuel consumption. In addition to the foregoing, covering the latch assembly 64 may also provide a safeguard against one or more of the latches 80 inadvertently remaining disengaged after the aircraft propulsion system 20 is maintained or inspected because the sleeve 56 cannot close or return to its stowed position when the latches are open and interfering.

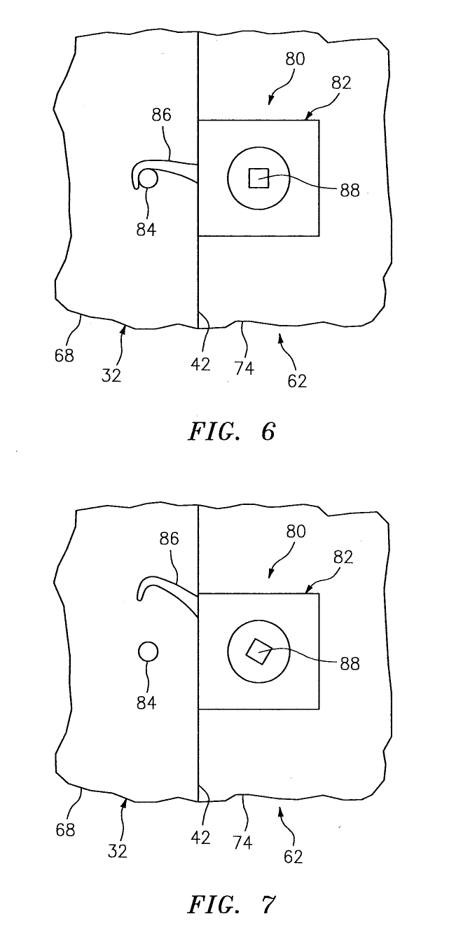

FIGS. 6 and 7 illustrate an exemplary embodiment of a manually operate latch 80. This latch 80 includes a rotary hook mechanism 82 and a stationary keeper 84; e.g., a pin. The rotary hook mechanism 82 includes a rotary hook 86 configured to rotate about an axis between an engaged position (see FIG. 6) and a disengaged position (see FIG. 7), which axis may be generally normal to the centerline 26. The rotation of the rotary hook 86 may be actuated by a tool, which may be mated with the rotary hook 86 via a feature 88 such as, but not limited to, a recess (e.g., a keyhole) configured to accept the tool. Alternatively, the rotary hook 86 may be configured with a handle (not shown).

In the engaged position, the rotary hook 86 engages (e.g., wraps partially around) the keeper 84 and thereby prevents at least axial movement between the rotary hook 86 and the keeper 84. In the disengaged position, the rotary hook 86 is disengaged from the keeper 84 and thereby enables at least axial movement between the rotary hook 86 and the keeper 84. In the embodiment of FIGS. 6 and 7, the rotary hook mechanism 82 is mounted to the stationary support 62 and the keeper 84 is mounted to the aft end portion 68 of the fanlet 32. However, in other embodiments, the rotary hook mechanism 82 may be mounted to the aft end portion 68 of the fanlet 32 and the keeper 84 may be mounted to the stationary support 62.

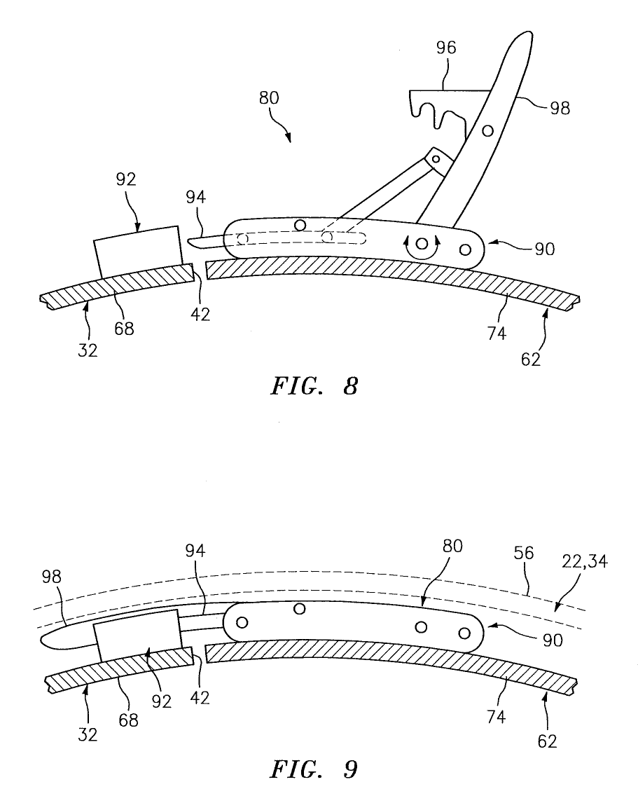

FIGS. 8 and 9 illustrate another exemplary embodiment of a manually operate latch 80. This latch 80 includes a latch mechanism 90 and a receiver block 92. The latch mechanism 90 includes a shear pin 94, a hook 96 and a handle 98. The shear pin 94 is coupled to the handle 98 in such a manner that pivoting the handle 98 towards the nacelle 22 causes the shear pin 94 to slide along an axis and into an aperture in the receiver block 92. The hook 96 is coupled to the handle 98 in such a manner that the pivoting the handle 98 towards the nacelle 22 causes the hook 96 to mate with the receiver block 92. In this engaged position, the latch 80 prevents movement between the latch mechanism 90 and the receiver block 92. In addition, the handle 98 is disposed substantially flat against the aft end portion 68 and/or the stationary support 62 enabling the forward end portion 70 to cover the entire latch 80 when the sleeve 56 is stowed (see dashed lines in FIG. 9). The forward end portion 70 of the sleeve 56 may also inhibit the handle 98 from disengaging the latch 80 since the sleeve 56 prevents pivoting of the handle 98 outward when the sleeve 56 is stowed.

In the embodiment of FIGS. 8 and 9, the latch mechanism 90 is mounted to the stationary support 62 and the receiver block 92 is mounted to the aft end portion 68 of the fanlet 32. However, in other embodiments, the latch mechanism 90 may be mounted to the aft end portion 68 of the fanlet 32 and the receiver block 92 may be mounted to the stationary support 62.

While several exemplary manually operated latches 80 are described above, various other types of manually operated and automated latches are known in the art. The present disclosure is not limited to any particular latch configurations.

In some embodiments, the fanlet 32 may be configured similar in relevant respects to the fanlet disclosed in U.S. Pat. No. 6,340,135 issued on Jan. 22, 2002, which shows a fanlet comprising a traditional nacelle inlet and a traditional nacelle fan cowl joined together as a single assembly, translatable together to move to an open position to gain maintenance access to the fan case. U.S. Pat. No. 6,340,135 is hereby incorporated herein by reference in its entirety.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

I claim:

1. A nacelle for an aircraft propulsion system, comprising:
a stationary support extending circumferentially about an axial centerline;
a forward nacelle structure configured to translate axially along the centerline between an aft stowed position and a forward deployed position;
a latch assembly configured to secure an aft end portion of the forward nacelle structure to the stationary support where the forward nacelle structure is in the aft stowed position; and
an aft nacelle structure a forward end portion of the aft nacelle structure axially covering the aft end portion of the forward nacelle structure and the latch assembly where the forward nacelle structure is in the aft stowed position.

2. The nacelle of claim 1, wherein the forward nacelle structure comprises a fanlet and the aft nacelle structure comprises a sleeve configured to translate axially along the centerline between a forward stowed position and an aft deployed position.

3. The nacelle of claim 1, wherein the forward nacelle structure comprises a fanlet, and wherein the fanlet comprises an inlet structure and a fan cowl.

4. The nacelle of claim 1, wherein the aft end portion of the forward nacelle structure axially overlaps the stationary support where the forward nacelle structure is in the aft stowed position.

5. The nacelle of claim 1, wherein the forward end portion of the aft nacelle structure is radially outboard of the aft end portion of the forward nacelle structure where the forward nacelle structure is in the aft stowed position.

6. The nacelle of claim 1, wherein, when the forward nacelle structure is in the aft stowed position, an exterior surface of the aft nacelle structure is substantially flush with and adjacent to an exterior surface of the forward nacelle structure.

7. The nacelle of claim 6, wherein the aft end portion of the forward nacelle structure is adjacent to and aft of the exterior surface of the forward nacelle structure.

8. The nacelle of claim 6, wherein the aft end portion of the forward nacelle structure is radially recess inward from the exterior of the forward nacelle structure and the exterior surface of the aft nacelle structure.

9. The nacelle of claim 1, wherein the latch assembly comprises a plurality of latches disposed circumferentially about the centerline.

10. The nacelle of claim 1, wherein the latch assembly comprises a manually operated latch.

11. The nacelle of claim 10, wherein
the latch comprises a handle operable to engage and disengage the latch where the aft nacelle structure is in the aft deployed position; and
the forward end portion of the aft nacelle structure is configured to inhibit the handle from disengaging the latch where the aft nacelle structure is in a forward stowed position.

12. The nacelle of claim 1, further comprising a thrust reverser system configured to operate where the aft nacelle structure is in an aft deployed position, wherein the stationary support comprises a torque box for the thrust reverser system.

13. A nacelle for an aircraft propulsion system, comprising:
a stationary support extending circumferentially about an axial centerline;
a fanlet including an inlet structure and a fan cowl, and axially translatable along the centerline;
a latch assembly configured to secure an aft end portion of the fanlet to the stationary support when the fanlet is stowed; and
a sleeve axially translatable along the centerline;
wherein, when the sleeve and the fanlet are stowed, the sleeve covers the latch assembly and an exterior surface of the sleeve is substantially flush with and adjacent to an exterior surface of the fanlet.

14. The nacelle of claim 13, wherein a forward end portion of the sleeve axially covers the aft end portion of the fanlet and the latch assembly where the fanlet and the sleeve are stowed.

15. The nacelle of claim 13, wherein the aft end portion of the fanlet axially overlaps the stationary support where the fanlet is stowed.

16. The nacelle of claim 13, wherein the aft end portion of the fanlet is adjacent to and aft of the exterior surface of the fanlet.

17. The nacelle of claim 13, wherein the aft end portion of the fanlet is radially recess inward from the exterior of the fanlet and the exterior surface of the sleeve.

18. The nacelle of claim 12, wherein the latch assembly comprises a plurality of latches disposed circumferentially about the centerline.

19. The nacelle of claim 13, wherein the latch assembly comprises a manually operated latch.

20. A method of securing a nacelle, comprising:
translating a fanlet from an open position to a closed position, the translating occurring in a direction substantially parallel to a centerline axis of the nacelle;
latching the fanlet to an aft stationary structure using one or more latches;
moving a portion of a thrust reverser to cover the one or more latches so the one or more latches are not exposed to any aerodynamic flow during flight.
